(19) United States
(12) Patent Application Publication
(10) Pub. No.: US 2023/0297946 A1
(43) Pub. Date: Sep. 21, 2023

(54) AUTOMATED RISK MANAGEMENT FOR AGING ITEMS MANAGED IN AN INFORMATION PROCESSING SYSTEM

(71) Applicant: Dell Products L.P., Round Rock, TX (US)

(72) Inventors: Shibi Panikkar, Bangalore (IN); Rohit Gosain, Bangalore (IN)

(21) Appl. No.: 17/697,037

(22) Filed: Mar. 17, 2022

(51) Int. Cl. G06Q 10/08; G06Q 10/06; G06Q 10/04

(52) U.S. Cl. CPC G06Q 10/087; G06Q 10/06315; G06Q 10/04

(57) ABSTRACT

Automated risk management techniques in an information processing system are disclosed. For example, for a given item type obtainable from two or more sources, wherein each of the two or more sources has an aging policy associated with the item type that is different with respect to one another, the method predicts a quantity of the item type obtainable from each of the two or more sources that is at risk during a given future time period based on the aging policy of each of the two or more sources. The method then determines one or more actions to be initiated to mitigate the quantity of the item type obtainable from each of the two or more sources that is at risk during the given future time period.

### FIELD

The field relates generally to information processing systems, and more particularly to automated risk management in such information processing systems.

### DESCRIPTION

There are many technical scenarios whereby entities attempt to manage items in their control with a goal of minimizing the risk of one or more negative consequences occurring as the items age. However, such conventional risk management techniques are largely manual and reactive in nature, and thus do not adequately minimize such risk. Illustrative technical scenarios may include use cases wherein the aging item at risk is an electronic data object or a physical part. Regardless, ineffective risk management can have significant negative consequences for an entity.

### SUMMARY

Illustrative embodiments provide automated risk management techniques in an information processing system.

For example, in an illustrative embodiment, for a given item type obtainable from two or more sources, wherein each of the two or more sources has an aging policy associated with the item type that is different with respect to one another, the method predicts a quantity of the item type obtainable from each of the two or more sources that is at risk during a given future time period based on the aging policy of each of the two or more sources. The method then determines one or more actions to be initiated to mitigate the quantity of the item type obtainable from each of the two or more sources that is at risk during the given future time period.

Advantageously, one or more illustrative embodiments provide automated risk management in a supply chain management environment that predict risk for each part and supplier which may result in negative consequences including, but not limited to, part shortage and/or loss. Based on the predicted risk, consumption shaping and/or return planning can be initiated to mitigate the predicted risk.

These and other illustrative embodiments include, without limitation, apparatus, systems, methods and computer program products comprising processor-readable storage media.

### BRIEF DESCRIPTION OF THE DRAWINGS

FIG. 1 illustrates an information processing system comprising a predictive risk management system according to an illustrative embodiment.

FIG. 2 illustrates a data table for a parts use case according to an illustrative embodiment.

FIG. 3 illustrates a system architecture of a predictive risk management system according to an illustrative embodiment.

FIG. 4 illustrates a data table for a parts use case according to an illustrative embodiment.

FIG. 5 illustrates a supply prediction architecture according to an illustrative embodiment.

FIG. 6 illustrates a data table for a parts use case according to an illustrative embodiment.

FIG. 7 illustrates a consumption prediction architecture according to an illustrative embodiment.

FIG. 8 illustrates a data table for a parts use case according to an illustrative embodiment.

FIG. 9 illustrates a data table for a parts use case according to an illustrative embodiment.

FIG. 10 illustrates a data table for a parts use case according to an illustrative embodiment.

FIG. 11 illustrates an example of a processing platform that may be utilized to implement at least a portion of an information processing system for automated risk management according to an illustrative embodiment.

### DETAILED DESCRIPTION

As mentioned, a physical part is one example of an item wherein ineffective risk management of the aging of the physical part can cause negative consequences for an entity. More particularly, a technical scenario in which risk management of a physical part can apply is supply chain management. Supply chain management in the manufacturing industry typically refers to the process of monitoring and taking actions required for a manufacturer, such as an original equipment manufacturer (OEM), to obtain raw materials (i.e., parts), and convert those parts into a finished product (equipment) that is then delivered to or otherwise deployed at a customer site. A goal of supply chain management with respect to the parts is to adequately balance supply and demand, e.g., the supply of the parts (the parts procured or otherwise acquired from vendors, etc.) with the demand of the parts (e.g., the parts needed to satisfy the manufacturing of equipment ordered by a customer). Management of the parts has been a challenge in the traditional and now modern supply chain processes.

Original equipment manufacturers (OEMs) typically procure parts in bulk based on a demand trigger. It is also typical practice for an OEM to source the total quantity needed for a given part type from different suppliers. If a part is not used, different suppliers have different part return policies (aging policies, as illustratively used herein), e.g., some suppliers have a 90-day return policy and some have 120-day return policy. Accordingly, if an unused part is not returned by the OEM to the vendor by the expiration of the return date (e.g., 90 or 120 days from OEM's receipt of the part), then the OEM may not be entitled to a refund (e.g., full or partial). Thus, in this illustrative OEM scenario, the term aging of a part illustratively refers to the length of time, since receipt, that the part has been in the inventory of the OEM without being consumed (e.g., used in an assembled unit of equipment or otherwise in the manufacturing process).

Currently, OEMs use a first-in-first-out (FIFO) consumption model for manufacturing a unit of equipment. That is, they use the earliest-received parts in their inventory and work their way forward in time through subsequently-received parts. OEMs also currently attempt to manually keep track, month-to-month, of the aging of each part, i.e., how long the part has been in the OEM's inventory, against the return policy of the vendor that supplied the part.

However, illustrative embodiments realize herein that the above-mentioned conventional methodology of tracking the aging of a part versus the return policy has several technical problems. By way of example only, there currently is no systematic view of different return policies of different vendors. As such, the procurement team of an OEM ends up missing deadlines for returning unused parts, causing the OEM to unnecessarily incur negative consequences such as, for example, significant costs. Further, current techniques for demand forecasting do not specify how many parts are going to be returned over a future time period (e.g., upcoming yearly-quarter). As such, demand and supply forecasts do not consider returning parts and end up with over stock or with shortages because they do not manage returns properly if at all.

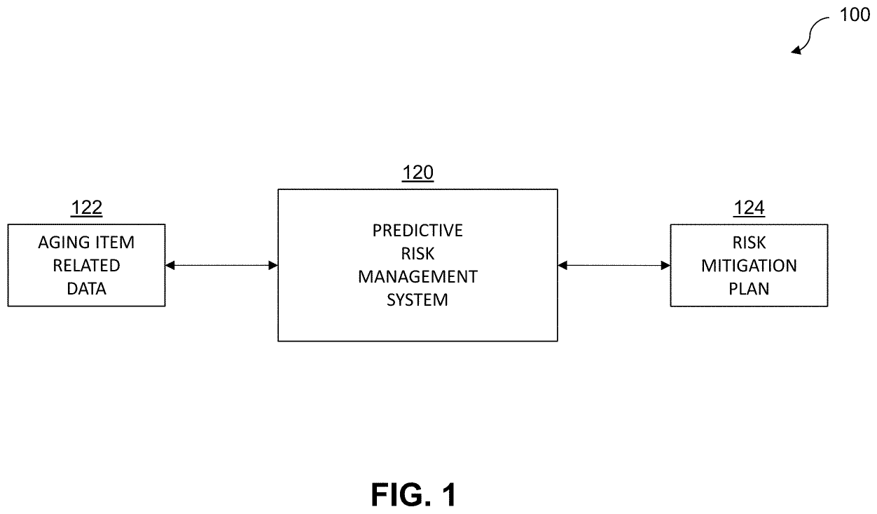

Illustrative embodiments overcome the above and other technical problems by providing an automated risk management system. By way of example, FIG. 1 illustrates an information processing system 100 comprising a predictive risk management system 120. As generally depicted, predictive risk management system 120 receives, as input, aging item related data 122 and generates, as output, a risk mitigation plan 124.

By way of example, predictive risk management system 120 is configured to predict different returnable parts based on different return policies (i.e., defined as part of aging item related data 122) and adjust demand planning or manufacturing planning to consume the parts in different ways with a goal to have zero or otherwise minimal part returns, and when the goal is predicted to not be achievable, then making preparations in advance for the subsequent return of parts by the deadlines (i.e., as part of risk mitigation plan 124).

Prior to describing illustrative automated risk management systems and methodologies according to illustrative embodiments, some illustrative use cases will be described for context.

Effective management of supply consumption is a technical problem with manufacturing organizations (e.g., OEMs) that procure raw material from suppliers and manufacture equipment using the raw materials. To avoid monopolization of a part, manufacturers source the same part from different suppliers or vendors. For example, an OEM who projects they will need 1000 hard disks for computer equipment they are manufacturing may order (source) 300 hard disks from Supplier 1, 500 from Supplier 2, and 200 from Supplier 3.

The payment and return policies of each supplier can be different. Assume for this example:
Supplier 1: Monthly payment with return policy of less than 90 days;
Supplier 2: Pay after use with return policy of less than 30 days; and
Supplier 3: Upfront payment with return policy of less than 120 days.

The technical problem is that once the parts from the various suppliers arrive at the manufacturing location, all the parts from every supplier go into a common inventory pool. The parts in the single inventory pool are then consumed for manufacturing orders in a FIFO manner, as mentioned above, with little or no regard for the return policy deadlines of each supplier.

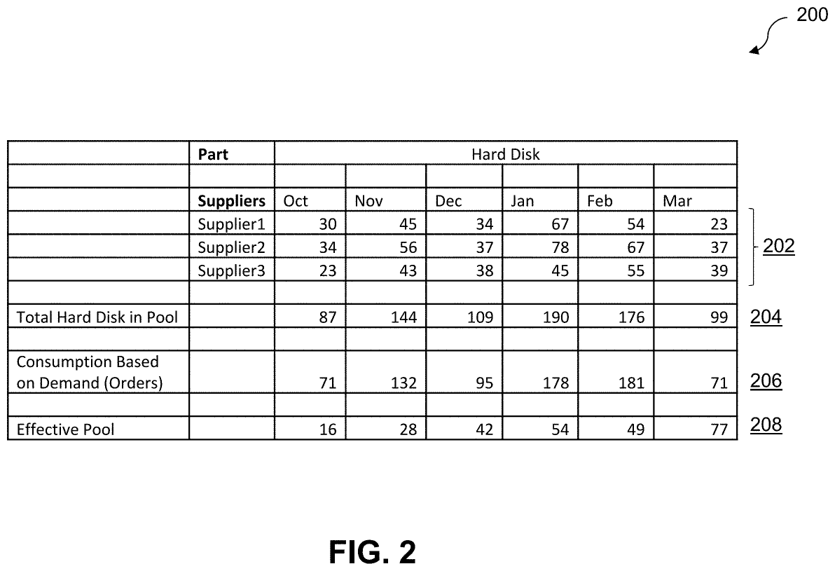

FIG. 2 is a table 200 illustrating a parts use case according to an illustrative embodiment. More particularly, table 200 illustrates a monthly inventory management scenario for hard disks received from Suppliers 1, 2 and 3, as mentioned above. Assume that the staggered (monthly) procurement of hard disks from each of the three suppliers is as depicted in portion 202 of table 200. Row 204 of table 200 depicts, for each month, the total number of hard disks in the common inventory pool. Row 206 of table 200 then depicts, for each month, consumption of the hard disks based on demand (manufacturing orders) wherein hard disks are taken from inventory in a FIFO manner. Lastly, row 208 of table 200 depicts, for each month, the accumulated remainder of hard disks in the common inventory pool.

With existing management approaches, assume that each month the procurement team views the remaining hard disks, analyzes the number, and returns at least a portion of unused hard disks to their respective suppliers. The first technical problem here is that, since hard disks are consumed in a FIFO manner, the amount remaining for each supplier is not readily visible requiring the procurement team to manually segregate the inventory and decide which hard disks are to be returned.

Further, with existing management approaches, assume at the end of December, the procurement team returns 30 parts to different suppliers. Assume further that the original demand planning and supply planning was done three months earlier in October. Thus, when demand planning occurred, there was no way the order management planner would have known that, at the end of December, 30 hard disks would be returned. Thus, it was assumed that there would be a 54 hard disk surplus at the end of January (given the previously computed demand forecast done in October). However, because a decision was made by the procurement team at the end of December to return 30 hard disks, there is only a 24 hard disk surplus at the end of January. As a result, there is an under-procurement of hard disks which leads to a shortage.

If the order management planner had visibility when demand/supply planning occurred in October that 30 hard disks would be returned at the end of December, they could have done better planning. For example:
(i) In October, if the order management planner knows 30 parts would be returning at the end of December, they can perform a demand planning adjustment to consume 30 hard disks by the end of December so that there will be zero returns.
(ii) In October, if the order management planner knows 25 parts out of 30 hard disks are from Supplier 1, they can perform part deviation in the order to consume more of the hard disks from Supplier 1 and make the returnable parts as near to zero as possible.
(iii) Since the procurement team does not have future visibility of how many parts are remaining for each supplier for the same part, and since the return policies of each supplier is different, it is difficult for the procurement team to manage the returns effectively.

Thus, in a supply chain scenario, different suppliers have different return policies (e.g., part life cycle). In existing management approaches, the returns are done on a month-to-month basis based on the current monthly view of remaining parts. As such, it is very difficult to analyze which suppliers and what quantity needs to be returned from the common inventory pool of parts. Incorrect returns lead to part shortages or late returns lead to cost to the organization. Since the order management planner does not have the future view of visibility of different supplier's parts remaining in future months, they cannot make a plan to effectively consume the parts in time using techniques such as part deviation, part substitution, finished goods assembly (FGA) stock, etc.

Accordingly, predictive risk management system 120 of FIG. 1 overcomes the above and other technical drawbacks associated with existing management approaches by generating a future view of returnable items for each supplier with different return policies using data obtained as part of aging item related data 122, and generating a demand adjustment as part of risk mitigation plan 124 to drive the number of parts returned to suppliers at or near zero.

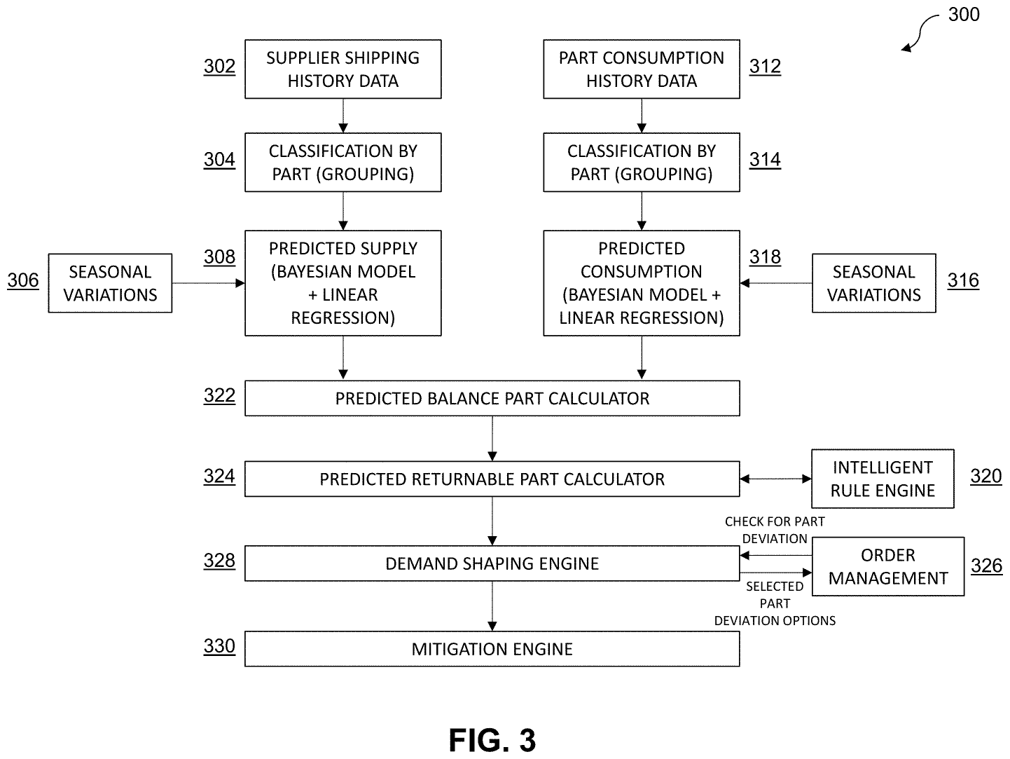

FIG. 3 illustrates a system architecture 300 of predictive risk management system 120 according to an illustrative embodiment. As shown, supplier shipping history data 302 is classified by part (e.g., simple grouping by the part type, e.g., hard disk) in a classification module 304 and then provided, with seasonal variation data 306, to a predicted supply module 308 which uses one or more artificial intelligence-based (machine learning) models and/or algorithms (e.g., Bayesian model and linear regression) to generate a predicted supply for each part type for multiple suppliers.

Similarly, part consumption history data 312 is classified by part (e.g., simple grouping by the part type, e.g., hard disk) in a classification module 314 and then provided, with seasonal variation data 316, to a predicted consumption module 318 which uses one or more artificial intelligence-based (machine learning) models and/or algorithms (e.g., Bayesian model and linear regression) to generate a predicted consumption for each part type, i.e., demand forecast for a given future time period such as, but not limited to, the next yearly-quarter.

An intelligent rule engine 320 maintains the attributes of the return policies (e.g., return deadlines and refund percentages) for the suppliers with a weightage of priority on each supplier (e.g., which supplier will cost the organization more if parts are not returned by the deadline).

The predicted supply from predicted supply module 308 and the demand forecast from predicted consumption module 318 are provided to a predicted balance part calculator 322 which predicts (e.g., using one or more machine learning algorithms/models), for each part type, how many parts will be remaining in the common inventory pool in the given future time period based on the predicted supply and predicted demand.

Based on the predicted remaining parts computed by predicted balance part calculator 322 and data maintained/computed by intelligent rule engine 320, a predicted returnable part calculator 324 predicts (e.g., using one or more machine learning algorithms/models) the number of returnable parts, for each part type, for each supplier.

An order management module 326 queries a demand shaping engine 328 which inputs the predicted number of returnable parts and the demand forecast, and generates a part deviation plan (e.g., instead of using one supplier's part, use another supplier's part) for the existing order to consume parts from suppliers that would have a larger impact on the OEM. The available part deviation options are provided to order management module 326 which can then instruct demand shaping engine 328 to instruct a mitigation engine 330 to implement a selected part deviation, e.g., consume more parts from a given supplier and/or stock parts for future customer orders. Mitigation engine 330 also identifies the parts to return, if any. That is, as mentioned above, a goal is to fully consume parts in the common inventory pool without incurring shortages and/or return policy deadline misses.

Thus, as described above, root data for system architecture 300 of predictive risk management system 120 comprises the history of part shipping from each supplier (302) and the history of consumption of the part (312). Classification of the root data (by modules 304 and 314) is based on the part and region and, in some embodiments, is done by simple grouping. Once grouped by the part, a Bayesian network is used (by modules 308 and 318) with seasonality variations (306 and 316) for forecasting parts available from suppliers (supply) and consumption of the parts in equipment manufacturing (demand).

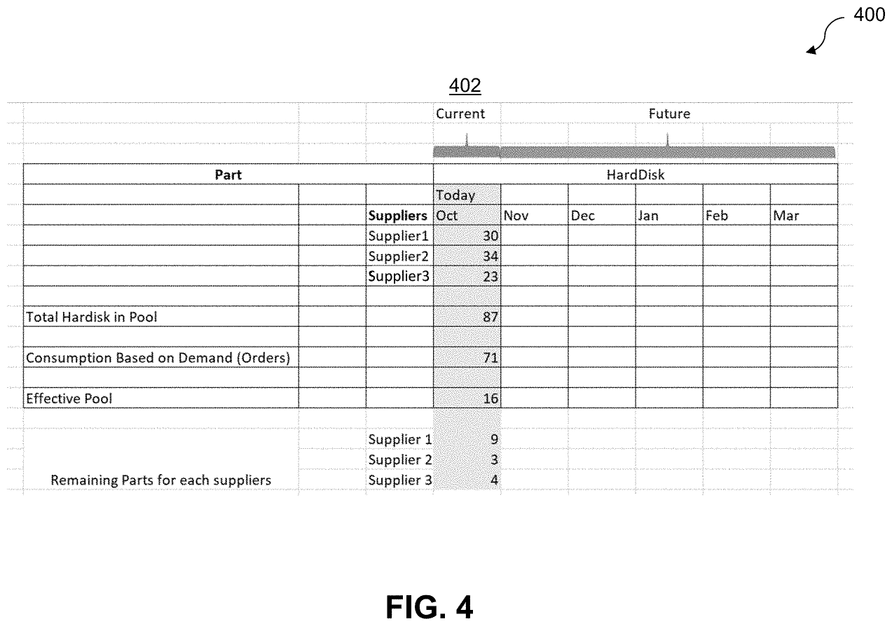

To further illustrate the technical problems that illustrative embodiments overcome, table 400 in FIG. 4 shows sample data with a hard disk as the part being managed. Referring to column 402 of table 400, assume “Today” refers to the date (e.g., October 31) that the procurement team looks into returning parts to suppliers. As indicated, there was a total of 87 hard disks in the pool with a consumption-to-date of 71 hard disks, thus leaving 16 remaining hard disks.

Using the existing management approach, for the 16 hard disks left in the pool, the procurement team performs analytics and determines that 9 hard disks are sourced from Supplier 1, 3 hard disks are sourced from Supplier 2, and 4 hard disks are sourced from Supplier 3. Now assume they look into the suppliers' return policies and return hard disks for that month to avoid being charged for them. However, as explained above, the procurement team does not know they are misbalancing the demand planning that done for next month. Due to this return, they can cause a parts shortage. However, if they did not return the hard disks that were close to or at the return deadline, it would cause cost to the OEM.

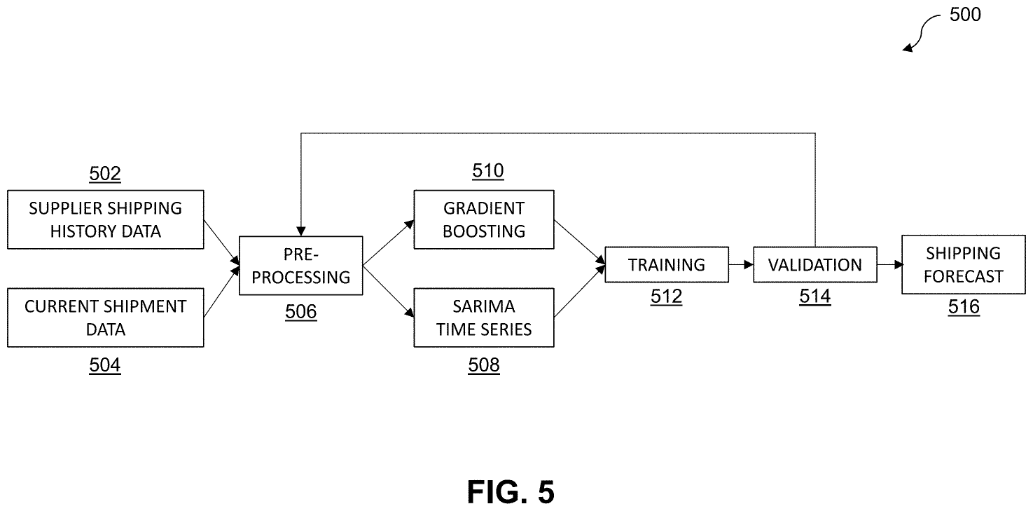

To overcome the technical problems of the existing management approach, system architecture 300 of predictive risk management system 120 utilizes predicted supply module 308 to provide a hybrid prediction approach using a Bayesian model and linear regression. FIG. 5 illustrates a supply prediction architecture 500 that can be implemented by predicted supply module 308 according to an illustrative embodiment.

It is realized that the supply data, i.e., supplier shipping history data 502 and current shipment data 504 can comprise linear data and non-linear data. After pre-processing 506 of the supplier shipping history data 502 and current shipment data 504 to classify the data into linear and non-linear for a specific part and supplier, the linear supply data with seasonality changes is provided to a SARIMA (Seasonal Autoregressive Integrated Moving Average) time series module 508 and the non-linear supply data is provided to a gradient boosting module 510.

SARIMA time series module 508 utilizes machine learning (ML) models (SARIMA models) that are the extension of an ARIMA model that supports univariate time series data involving backshifts of the seasonal period.

Gradient boosting module 510 is an ensemble technique that takes a group of ML models that are weak learners and uses them to create a strong learner. More particularly, gradient boosting module 510 combines weak learners by iteratively focusing on errors resulting at each step until a suitable strong learner is obtained as a sum of the successive weak learners.

Respective outputs of SARIMA time series module 508 and gradient boosting module 510 are provided to a training module 512 and a validation module 514 to support the hybrid prediction. By way of example, training module 512 and validation module 514 may use experiential data from the procurement team to modify and retrain by modifying the average model in time series and validation of the actual output and re-processing for the gradient boosting. A shipping (supply) forecast 516 results from the hybrid prediction process executed in supply prediction architecture 500.

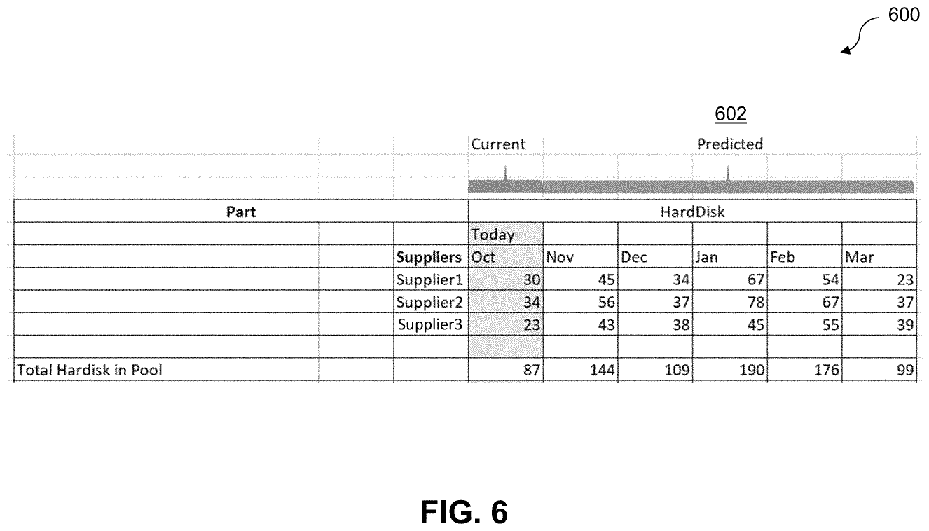

FIG. 6 illustrates a table 600 with supply prediction results shown in columns 602 that are computed as described in supply prediction architecture 500 of FIG. 5. Accordingly, utilizing supply prediction architecture 500 in predicted supply module 308, the total predicted supply in the given future time period (e.g., upcoming next 5 months as illustratively shown) is obtained. Initially, in some embodiments, there can be around 10-15% error in the prediction. However, this is advantageously taken care of in demand shaping engine 328. Moreover, over a period time, the error becomes considerably less due to continuous learning.

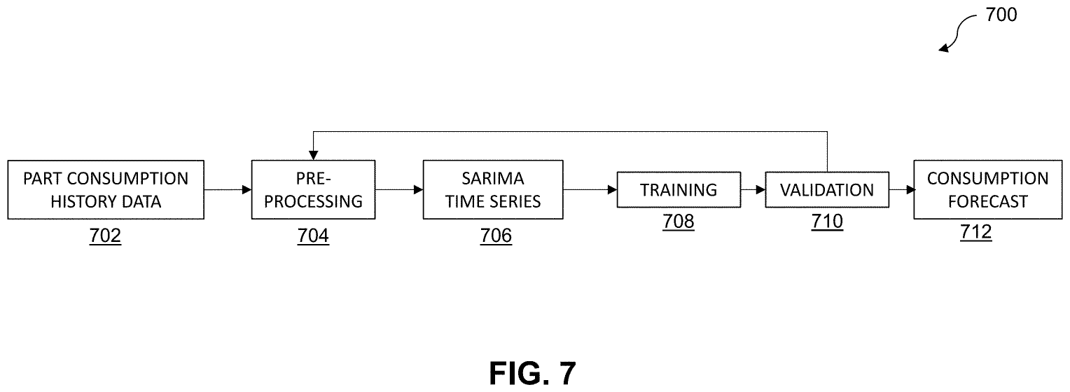

Turning now to predicting the consumption, recall that system architecture 300 of predictive risk management system 120 utilizes predicted consumption module 318 to provide a hybrid prediction approach using a Bayesian model and linear regression. FIG. 7 illustrates a consumption prediction architecture 700 that can be implemented by predicted consumption module 318 according to an illustrative embodiment.

Consumption prediction architecture 700 inputs part consumption history 702 (312 in FIG. 3) and processes the input data utilizing a pre-processing module 704, a SARIMA time series module 706, a training module 708, and a validation module 710 in a similar manner as supply prediction architecture 500 in FIG. 5 processes linear supply data. The SARIMA time series model accommodates the consumption data due to the linearity in the data set with seasonality changes. A consumption forecast 712 is output by consumption prediction architecture 700.

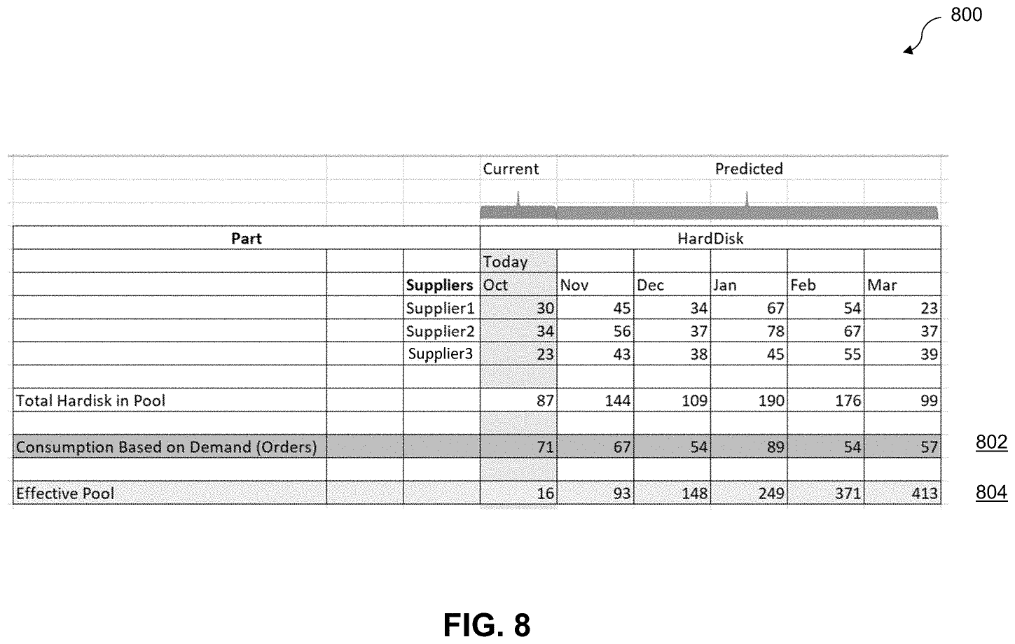

FIG. 8 illustrates a table 800 with consumption prediction results shown in row 802 that are computed as described in consumption prediction architecture 700 of FIG. 7. Row 804 illustrates the computed Effective Pool as (Total Pool−Consumption)+Previous Effective Pool.

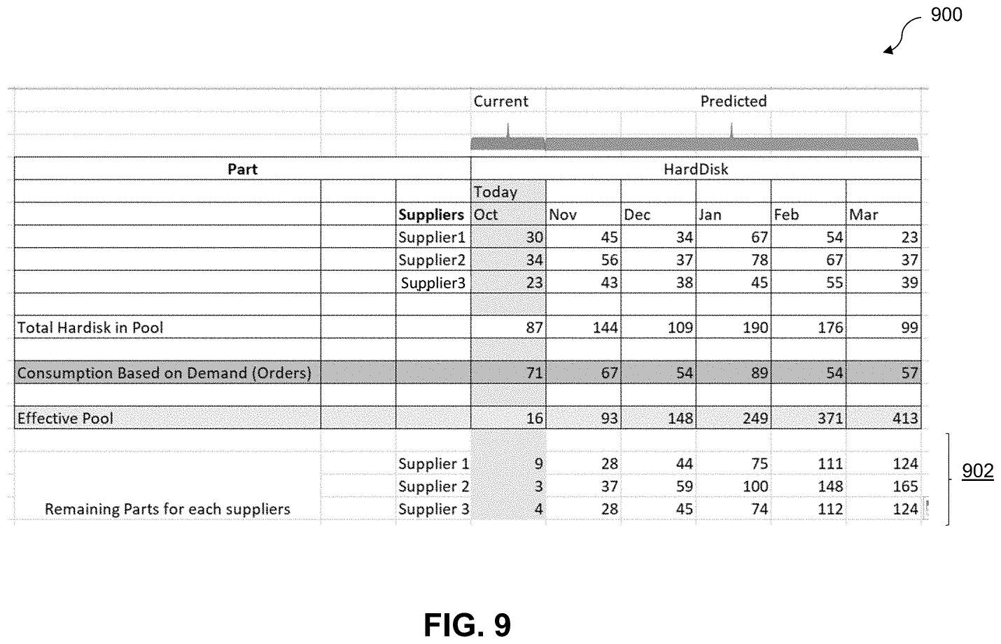

It is realized herein that since the pool contains all suppliers' parts and each supplier's return policy is different, the order management team cannot treat all of these with the same strategy for different consumptions to manage the pool to zero (or near zero). As such, the predicted contribution by each supplier in the effective pool is determined as illustrated portion 902 of table 900 of FIG. 9.

Currently, the procurement team uses a statistical method for the current month. As given in the data of table 900, the current month Effective Pool is 16, and each supplier data is 9, 3 and 4, respectively. Thus, the system tries to find the trending ratio of suppliers over a time period. If consumption uses the parts in the same ratio of purchase, then the purchase ratio can be used. However, some OEMs employ a common pool and use FIFO-based consumption. So, the consumption depends on the shipment from the supplier. But in this case, if the trend of remaining parts over a month can be obtained, the ratio prediction can be obtained. Once the prediction of the ratio is obtained (in this example, the ratio is 3:4:3), portion 902 shows the predicted consumption based on supplier over the given future time periods (e.g., upcoming 5 months). Returning to FIG. 3, recall that system architecture 300 finds the parts in risk by considering the suppliers' policies. Intelligent rule engine 320 is used to facilitate this step. Recall that the suppliers' policies in the illustrative use case are as follows:
Supplier 1: Monthly payment. Return policy of less than 90 days.
Supplier 2: Pay after use. Return Policy less than 30 days.
Supplier 3: Upfront Payment. Return Policy less than 120 days.

Since the system handles consumption in a FIFO manner, it will instruct to consume first shipment parts and then second shipment parts at some point of time. Intelligent rule engine 320 converts the policies as follows:

Supplier 1 policy converts (Return policy less than 90 days) to a rule as follows:
If ((N+(N−1)+N−2)−C)>N−2) then Difference is at Risk

Supplier 2 policy converts (Return policy less than 30 days) to a rule as follows:
If ((N−C)>N) then Difference is at Risk

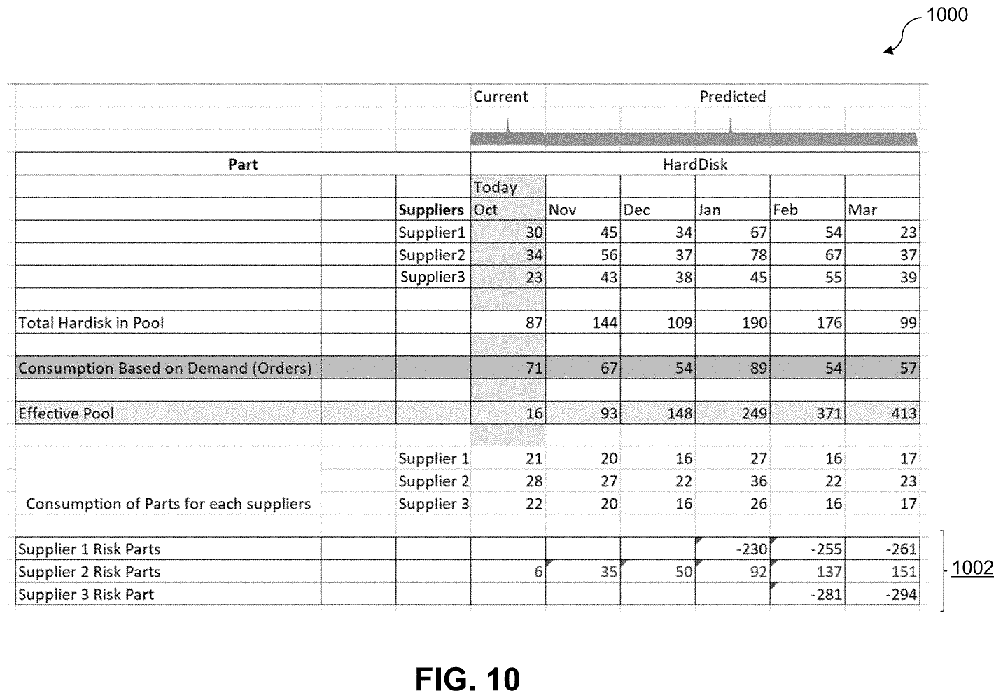

Supplier 3 policy converts (Return policy less than 120 days) to a rule as follows:
If ((N+(N−1)+N−2+N−3)−C)>N−3) then Difference is at Risk
   where N equals the current month purchase, (N−1) equals the previous month purchase, etc., and D equals the consumption so far. Portion 1002 of table 1000 of FIG. 10 illustrates the at-risk parts for each supplier based on application of the above rules on the current data. As shown, Supplier 1 and 3 have negative numbers for parts at risk which means their parts are not of concern. However, there are parts at risk each month for Supplier 2. Given this information, demand shaping engine 328 and mitigation engine 330 are used to implement a mitigation plan.

As per the data in the FIG. 10 use case, only Supplier 2 parts are at risk. Supplier 1 and Supplier 3 parts are not at risk with enough buffer, e.g., Supplier 1 has 230 parts short of cutoff for return in January, and Supplier 3 has 281 parts short of cutoff for return in February. In this scenario, demand shaping engine 328 suggests a part deviation plan. In part deviation, according to one example, the upcoming order will be sourced from Supplier 2 until the surplus becomes zero. For example, in the FIG. 10 use case in November, order management module 326 will plan that the next 35 orders for the given part will be sourced from Supplier 2 so that the risk is zero. If all or a majority of suppliers' parts are at risk, then demand shaping engine 328 suggests a new finished goods assembly (FGA) to be manufactured and stocked using at risk parts and drives the risk to zero. The procurement team can return the surplus parts to minimize the risk. In illustrative embodiments, demand shaping engine 328 gives all options so that order management module 326 can make a decision, which is then implemented as the mitigation plan by mitigation engine 330.

Illustrative embodiments are described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Cloud infrastructure can include private clouds, public clouds, and/or combinations of private/public clouds (hybrid clouds).

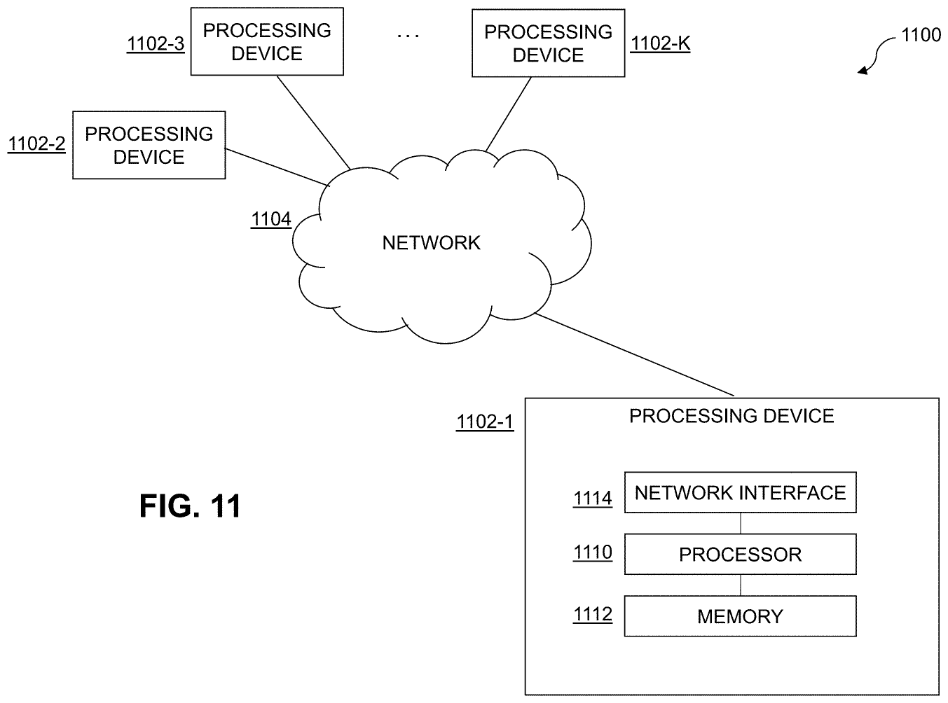

FIG. 11 depicts a processing platform 1100 used to implement systems/processes/data 100 through 1000 depicted in FIGS. 1 through 10, respectively, according to an illustrative embodiment. More particularly, processing platform 1100 is a processing platform on which a computing environment with functionalities described herein can be implemented.

The processing platform 1100 in this embodiment comprises a plurality of processing devices, denoted 1102-1, 1102-2, 1102-3, . . . 1102-K, which communicate with one another over network(s) 1104. It is to be appreciated that the methodologies described herein may be executed in one such processing device 1102, or executed in a distributed manner across two or more such processing devices 1102. It is to be further appreciated that a server, a client device, a computing device or any other processing platform element may be viewed as an example of what is more generally referred to herein as a “processing device.” As illustrated in FIG. 11, such a device generally comprises at least one processor and an associated memory, and implements one or more functional modules for instantiating and/or controlling features of systems and methodologies described herein. Multiple elements or modules may be implemented by a single processing device in a given embodiment. Note that components described in the architectures depicted in the figures can comprise one or more of such processing devices 1102 shown in FIG. 11. The network(s) 1104 represent one or more communications networks that enable components to communicate and to transfer data therebetween, as well as to perform other functionalities described herein.

The processing device 1102-1 in the processing platform 1100 comprises a processor 1110 coupled to a memory 1112. The processor 1110 may comprise a microprocessor, a microcontroller, an application-specific integrated circuit (ASIC), a field programmable gate array (FPGA) or other type of processing circuitry, as well as portions or combinations of such circuitry elements. Components of systems as disclosed herein can be implemented at least in part in the form of one or more software programs stored in memory and executed by a processor of a processing device such as processor 1110. Memory 1112 (or other storage device) having such program code embodied therein is an example of what is more generally referred to herein as a processor-readable storage medium. Articles of manufacture comprising such computer-readable or processor-readable storage media are considered embodiments of the invention. A given such article of manufacture may comprise, for example, a storage device such as a storage disk, a storage array or an integrated circuit containing memory. The term “article of manufacture” as used herein should be understood to exclude transitory, propagating signals.

Furthermore, memory 1112 may comprise electronic memory such as random-access memory (RAM), read-only memory (ROM) or other types of memory, in any combination. The one or more software programs when executed by a processing device such as the processing device 1102-1 causes the device to perform functions associated with one or more of the components/steps of system/methodologies in FIGS. 1 through 5. One skilled in the art would be readily able to implement such software given the teachings provided herein. Other examples of processor-readable storage media embodying embodiments of the invention may include, for example, optical or magnetic disks.

Processing device 1102-1 also includes network interface circuitry 1114, which is used to interface the device with the networks 1104 and other system components. Such circuitry may comprise conventional transceivers of a type well known in the art.

The other processing devices 1102 (1102-2, 1102-3, . . . 1102-K) of the processing platform 1100 are assumed to be configured in a manner similar to that shown for computing device 1102-1 in the figure.

The processing platform 1100 shown in FIG. 11 may comprise additional known components such as batch processing systems, parallel processing systems, physical machines, virtual machines, virtual switches, storage volumes, etc. Again, the particular processing platform shown in this figure is presented by way of example only, and the system shown as 1100 in FIG. 11 may include additional or alternative processing platforms, as well as numerous distinct processing platforms in any combination.

Also, numerous other arrangements of servers, clients, computers, storage devices or other components are possible in processing platform 1100. Such components can communicate with other elements of the processing platform 1100 over any type of network, such as a wide area network (WAN), a local area network (LAN), a satellite network, a telephone or cable network, or various portions or combinations of these and other types of networks.

Furthermore, it is to be appreciated that the processing platform 1100 of FIG. 11 can comprise virtual (logical) processing elements implemented using a hypervisor. A hypervisor is an example of what is more generally referred to herein as “virtualization infrastructure.” The hypervisor runs on physical infrastructure. As such, the techniques illustratively described herein can be provided in accordance with one or more cloud services. The cloud services thus run on respective ones of the virtual machines under the control of the hypervisor. Processing platform 1100 may also include multiple hypervisors, each running on its own physical infrastructure. Portions of that physical infrastructure might be virtualized.

As is known, virtual machines are logical processing elements that may be instantiated on one or more physical processing elements (e.g., servers, computers, processing devices). That is, a “virtual machine” generally refers to a software implementation of a machine (i.e., a computer) that executes programs like a physical machine. Thus, different virtual machines can run different operating systems and multiple applications on the same physical computer. Virtualization is implemented by the hypervisor which is directly inserted on top of the computer hardware in order to allocate hardware resources of the physical computer dynamically and transparently. The hypervisor affords the ability for multiple operating systems to run concurrently on a single physical computer and share hardware resources with each other.

It was noted above that portions of the computing environment may be implemented using one or more processing platforms. A given such processing platform comprises at least one processing device comprising a processor coupled to a memory, and the processing device may be implemented at least in part utilizing one or more virtual machines, containers or other virtualization infrastructure. By way of example, such containers may be Docker containers or other types of containers.

The particular processing operations and other system functionality described in conjunction with FIGS. 1-11 are presented by way of illustrative example only, and should not be construed as limiting the scope of the disclosure in any way. Alternative embodiments can use other types of operations and protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should again be emphasized that the above-described embodiments of the invention are presented for purposes of illustration only. Many variations may be made in the particular arrangements shown. For example, although described in the context of particular system and device configurations, the techniques are applicable to a wide variety of other types of data processing systems, processing devices and distributed virtual infrastructure arrangements. In addition, any simplifying assumptions made above in the course of describing the illustrative embodiments should also be viewed as exemplary rather than as requirements or limitations of the invention.

What is claimed is:

1. An apparatus comprising:
at least one processing device comprising a processor coupled to a memory, the at least one processing device, when executing program code, is configured to:
for a given item type obtainable from two or more sources, wherein each of the two or more sources has an aging policy associated with the item type that is different with respect to one another;
predict a quantity of the item type obtainable from each of the two or more sources that is at risk during a given future time period based on the aging policy of each of the two or more sources; and
determine one or more actions to be initiated to mitigate the quantity of the item type obtainable from each of the two or more sources that is at risk during the given future time period.

2. The apparatus of claim 1, wherein predicting the quantity of the item type obtainable from each of the two or more sources that is at risk during the given future time period based on the aging policy of each of the two or more sources further comprises:
obtaining data representing, for each of the two or more sources, a supply history for obtaining the item type; and
generating a supply prediction, for each of the two or more sources, for the item type for the given future time period based on the obtained data.

3. The apparatus of claim 2, wherein predicting the quantity of the item type obtainable from each of the two or more sources that is at risk during the given future time period based on the aging policy of each of the two or more sources further comprises:
obtaining data representing a consumption history for the item type; and
generating a consumption prediction for the item type for the given future time period based on the obtained data.

4. The apparatus of claim 3, wherein predicting the quantity of the item type obtainable from each of the two or more sources that is at risk during the given future time period based on the aging policy of each of the two or more sources further comprises:
predicting a remaining balance of the item type for the given future time period based on the supply prediction and the consumption prediction.

5. The apparatus of claim 4, wherein predicting the quantity of the item type obtainable from each of the two or more sources that is at risk during the given future time period based on the aging policy of each of the two or more sources further comprises:
predicting a quantity of the remaining balance of the item type for the given future time period to be returned to the two or more sources based on the aging policy of each of the two or more sources.

6. The apparatus of claim 5, wherein determining the one or more actions to be initiated to mitigate the quantity of the item type obtainable from each of the two or more sources that is at risk during the given future time period further comprises:
determining one or more consumption deviation actions to decrease the predicted quantity of the remaining balance of the item type for the given future time period to be returned to the two or more sources.

7. The apparatus of claim 1, wherein predicting the quantity of the item type obtainable from each of the two or more sources that is at risk during the given future time period based on the aging policy of each of the two or more sources further comprises executing one or more machine learning algorithms.

8. The apparatus of claim 1, wherein the item type comprises a part used in a manufacturing process and the aging policy of each of the two or more sources comprises a part return policy.

9. The apparatus of claim 1, wherein the given future time period comprises two or more consecutive time periods such that predicting the quantity of the item type obtainable from each of the two or more sources that is at risk based on the aging policy of each of the two or more sources is computed for each of the two or more consecutive time periods.

10. A method comprising:
for a given item type obtainable from two or more sources, wherein each of the two or more sources has an aging policy associated with the item type that is different with respect to one another;
predicting a quantity of the item type obtainable from each of the two or more sources that is at risk during a given future time period based on the aging policy of each of the two or more sources; and
determining one or more actions to be initiated to mitigate the quantity of the item type obtainable from each of the two or more sources that is at risk during the given future time period;
wherein the predicting and determining steps are performed by at least one processing device comprising a processor coupled to a memory when executing program code.

11. The method of claim 10, wherein predicting the quantity of the item type obtainable from each of the two or more sources that is at risk during the given future time period based on the aging policy of each of the two or more sources further comprises:
obtaining data representing, for each of the two or more sources, a supply history for obtaining the item type; and
generating a supply prediction, for each of the two or more sources, for the item type for the given future time period based on the obtained data.

12. The method of claim 11, wherein predicting the quantity of the item type obtainable from each of the two or more sources that is at risk during the given future time period based on the aging policy of each of the two or more sources further comprises:
obtaining data representing a consumption history for the item type; and
generating a consumption prediction for the item type for the given future time period based on the obtained data.

13. The method of claim 12, wherein predicting the quantity of the item type obtainable from each of the two or more sources that is at risk during the given future time period based on the aging policy of each of the two or more sources further comprises:
predicting a remaining balance of the item type for the given future time period based on the supply prediction and the consumption prediction.

14. The method of claim 13, wherein predicting the quantity of the item type obtainable from each of the two or more sources that is at risk during the given future time period based on the aging policy of each of the two or more sources further comprises:
predicting a quantity of the remaining balance of the item type for the given future time period to be returned to the two or more sources based on the aging policy of each of the two or more sources.

15. The method of claim 14, wherein determining the one or more actions to be initiated to mitigate the quantity of the item type obtainable from each of the two or more sources that is at risk during the given future time period further comprises:
determining one or more consumption deviation actions to decrease the predicted quantity of the remaining balance of the item type for the given future time period to be returned to the two or more sources.

16. The method of claim 10, wherein predicting the quantity of the item type obtainable from each of the two or more sources that is at risk during the given future time period based on the aging policy of each of the two or more sources further comprises executing one or more machine learning algorithms.

17. The method of claim 10, wherein the item type comprises a part used in a manufacturing process and the aging policy of each of the two or more sources comprises a part return policy.

18. The method of claim 10, wherein the given future time period comprises two or more consecutive time periods such that predicting the quantity of the item type obtainable from each of the two or more sources that is at risk based on the aging policy of each of the two or more sources is computed for each of the two or more consecutive time periods.

19. A computer program product comprising a non-transitory processor-readable storage medium having stored therein program code of one or more software programs, wherein the program code when executed by at least one processing device cause the at least one processing device to:
for a given item type obtainable from two or more sources, wherein each of the two or more sources has an aging policy associated with the item type that is different with respect to one another;
predict a quantity of the item type obtainable from each of the two or more sources that is at risk during a given future time period based on the aging policy of each of the two or more sources; and
determine one or more actions to be initiated to mitigate the quantity of the item type obtainable from each of the two or more sources that is at risk during the given future time period.

20. The computer program product of claim 19, wherein the given future time period comprises two or more consecutive time periods such that predicting the quantity of the item type obtainable from each of the two or more sources that is at risk based on the aging policy of each of the two or more sources is computed for each of the two or more consecutive time periods.
